(19) United States
(12) Patent Application Publication
(10) Pub. No.: US 2018/0365715 A1
(43) Pub. Date: Dec. 20, 2018

(54) METHOD AND SYSTEM FOR PURCHASE BEHAVIOR PREDICTION OF CUSTOMERS

(71) Applicant: Tata Consultancy Services Limited, Mumbai (IN)

(72) Inventors: Pankaj MALHOTRA, Noida (IN); Gaurangi ANAND, Noida (IN); Auon HAIDAR KAZMI, Noida (IN); Lovekesh VIG, Gurgaon (IN); Puneet AGARWAL, Noida (IN); Gautam Shroff, Gurgaon (IN)

(73) Assignee: Tata Consultancy Services Limited, Mumbai (IN)

(21) Appl. No.: 15/781,431

(22) PCT Filed: Dec. 2, 2016
(86) PCT No.: PCT/IB2016/057292

§ 371 Date: Jun. 4, 2018

(30) Foreign Application Priority Data
Dec. 2, 2015 (IN) 4550/MUM/2015

(51) Int. Cl. G06Q 30/02; G06N 5/04; G06Q 30/06; G06N 7/00

(52) U.S. Cl. CPC G06Q 30/0202; G06N 7/00; G06Q 30/06; G06N 5/043

(57) ABSTRACT

A method and a system to enable customer behavior prediction are disclosed. Temporal and aggregate features with respect to purchases made by a customer are extracted from purchase history of customers. Further, temporal and aggregate models are generated corresponding to the features extracted, wherein the temporal and aggregate models are data of a first type and data of a second type respectively. Further, a Mixture of Experts (ME) is used to process the temporal and aggregate models that are of different types of data, to build a combined model, and purchase behavior of the customer is identified based on the combined model.

### CROSS-REFERENCE TO RELATED APPLICATIONS AND PRIORITY

The present application claims priority to a Patent Application Serial Number 4550/MUM/2015, filed before Indian Patent Office on 02/Dec./2015 and incorporates that application in its entirety.

### TECHNICAL FIELD

The embodiments herein generally relate to data analytics, and, more particularly, to a method and system for predicting purchase behavior of customers by combining temporal and aggregate models.

### DESCRIPTION OF THE RELATED ART

Consumer brands often run promotional campaigns and offer discounts or coupons to attract new customers. After such promotional campaigns, it is important to identify the customers who are more likely to make a repeat purchase after the initial incentivized purchase. By focusing on these potential loyal customers in future targeted marketing campaigns, merchants can greatly reduce promotional costs and enhance the return on investment (ROI). This also helps in making pertinent and useful offers to customers. Every retail store has a large number of customers who interact with it. The future purchase behavior of the customers is required to be predicted after giving the customers offers as a part of a promotional campaign, based on the interactions of the customers available with the store.

State-of-the-art systems consider basket-level transaction history to predict the repeat purchase behavior of customers. The basket level information, which actually is aggregate information, involves type of goods purchased by a customer, number of each item purchased, overall purchases made over a period of time and so on. However, the aggregate information may not give a clear picture of purchase pattern of a customer. This is because the aggregate information covers only limited features of a customer behavior, which adversely affects accuracy of any behavior prediction based on the aggregate information.

### SUMMARY

Embodiments of the present disclosure present technological improvements as solutions to one or more of the above-mentioned technical problems recognized by the inventors in conventional systems. For example, in one embodiment, a method and a data analytics server for customer behavior assessment are provided. The data analytics server comprising a hardware processor; and a storage medium comprising a plurality of instructions, the plurality of instructions causing the hardware processor to fetch dynamically, a purchase history of at least one customer, by an Input/Output (I/O) interface of the data analytics server, wherein the purchase history comprises of at least one of customer features, product features, and customer-product interaction features. An aggregate model for the purchase history is generated by a data processing module of the data analytics server, wherein the aggregate model comprises of data of a first type, and a temporal model for the purchase history is generated by the data analytics module, wherein the temporal model comprises of data of a second type. Further, a combined model is determined based on the aggregate model and the temporal model, using Mixture of Experts (ME), by a prediction engine of the data analytics server, the prediction engine determines the final prediction score by processing the data of the first type and the data of the second type using ME. Further, the at least one customer is classified as one of a repeat customer and a non-repeating customer, based on the combined model, by the prediction engine.

In another aspect, a method for customer behavior assessment is provided. In this method, a purchase history of at least one customer is fetched dynamically, wherein the purchase history comprises of at least one of customer features, product features, and customer-product interaction features, by a data analytics server. Further, an aggregate model for the purchase history is generated, wherein the aggregate model comprises of data of a first type, by the data analytics server. Further, a temporal model is generated for the purchase history, by the data analytics server, wherein the temporal model comprises of data of a second type. Further, a combined model is determined based on the aggregate model and the temporal model, using Mixture of Experts (ME), by the data analytics server, wherein the ME determines the combined model by processing the data of the first type and the data of the second type. The at least one customer is then classified as one of a repeat customer and a non-repeating customer, based on the combined model, by the data analytics server.

It is to be understood that both the foregoing general description and the following detailed description are exemplary and explanatory only and are not restrictive of the invention, as claimed.

### BRIEF DESCRIPTION OF THE DRAWINGS

The embodiments herein will be better understood from the following detailed description with reference to the drawings, in which:

FIG. 1 illustrates a block diagram of a data analytics system, in accordance with an example embodiment;

FIG. 2 is a block diagram that depicts components of a data analytics server of the data analytics system, in accordance with an example embodiment;

FIG. 3 is a flow diagram that depicts steps involved in the process of performing data analytics and prediction using the data analytics system, in accordance with an example embodiment;

FIG. 4 is a flow diagram that depicts steps involved in the process of categorizing a customer as a repeater or non-repeater, using the data analytics system, in accordance with an example embodiment;

FIG. 5 is a block diagram of a system for generation of proof explanation in predicting purchase behavior of customers, in an embodiment; and

FIGS. 6a, 6b, and 6c depict experimental data associated with working of the data analytics system, in accordance with an embodiment.

### DETAILED DESCRIPTION

The embodiments herein and the various features and advantageous details thereof are explained more fully with reference to the non-limiting embodiments that are illustrated in the accompanying drawings and detailed in the following description. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The disclosed embodiments relate to a mechanism of classifying a customer as a repeater or a non-repeater based on his/her previous interaction with one or more stores, and various offers availed by the customer. A repeater is a customer who ends up making a repeat purchase of one or more products considered, wherein the repeat purchase behavior is characterized in terms of parameters such as but not limited to brand, merchant, shop from where the purchase is being made, and company of the product(s) being purchased. In various embodiments, all relevant information such as but not limited to details of the customers, details of offers and so on are extracted from the transaction data to form a purchase history specific to a customer, and then the purchase behavior of the customer is predicted.

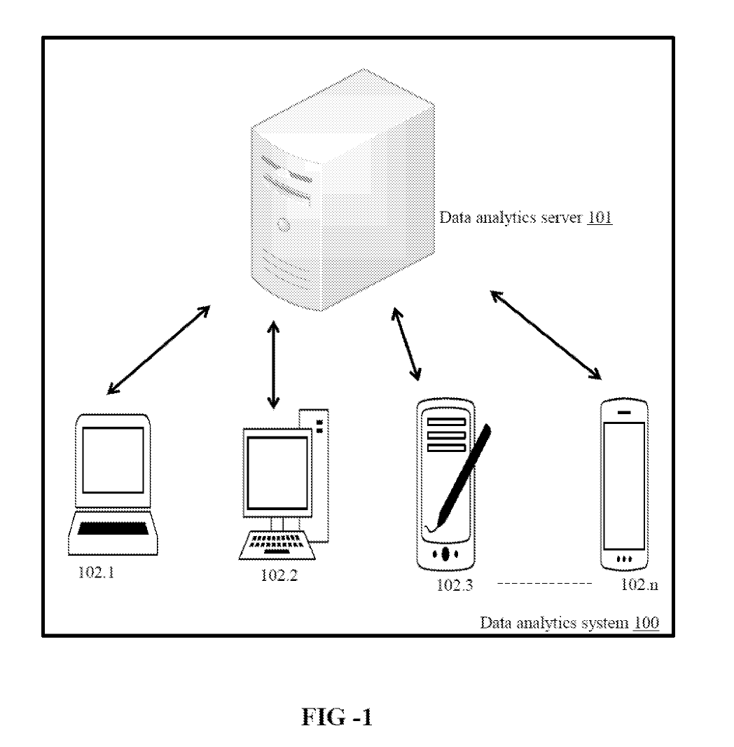

The embodiments herein provide a system and method to enable customer behavior assessment and in turn predict an expected purchase pattern of the customer. The ‘purchase pattern’ indicates characteristics of the purchases made by the customer over a period of time, with respect to certain pre-defined parameters, and in turn helps to categorize customers as repeaters and non-repeating customers. For example, the disclosed system enables customer behavior prediction based on transaction history by utilizing various aggregate functions. Referring now to the drawings, and more particularly to FIGS. 1 through 6, where similar reference characters denote corresponding features consistently throughout the figures, there are shown preferred embodiments and these embodiments are described in the context of the following exemplary system and/or method.

FIG. 1 illustrates a network implementation 100 for customer behavior prediction, in accordance with an embodiment of the present subject matter. The network implementation 100 includes a data analytics server 101, and at least one user device 102. The user device 102 can be a laptop 102.a, a desktop computer 102.b, a Personal Digital Assistant (PDA) 102.c, a smartphone 102.n, and/or any such device that is capable of establishing a communication with the data analytics server 101 through at least one suitable channel, at least for the purpose of customer behavior prediction related data and control signal exchange. Further, ‘user devices 102’ can refer to the devices being used by the customers, or one or more devices installed at a service providing center, from which purchase history of one or more customers can be collected for behavior prediction purposes. For example, in an implementation scenario, the user device 102 can refer to a smartphone being used by a customer, details of purchases made by that particular customer can be extracted from that smartphone, by the data analytics server 101. In another implementation scenario, the user device 102 is a data repository located at the service providing center, which possesses information related to purchases made by one or more customers at least over a particular time period. Further, when the data analytics server 101 is deployed in a cloud environment and it needs to collect purchase history information for at least one customer from at least two user devices 102 over a network, the data is associated with a unique identifier assigned to that particular customer, so that the data analytics server 101 can differentiate between data associated with different customers.

In various embodiments, the data analytics server 101 is placed in a local network and/or is hosted on cloud network or other similar services, and the data analytics server 101 establishes communication with the user devices 102 over a network. Further, the network can be a wireless network, a wired network or a combination thereof. The network can be implemented as one of the different types of networks, such as intranet, local area network (LAN), wide area network (WAN), the Internet, and so on. The network may either be a dedicated network or a shared network. The network represents an association of the different types of networks that use a variety of protocols, for example, Hypertext Transfer Protocol (HTTP), Transmission Control Protocol/Internet Protocol (TCP/IP), Wireless Application Protocol (WAP), and so on, to communicate with one another. Further the network may include a variety of network devices, including routers, bridges, servers, computing devices, storage devices, and the like.

The data analytics server 101 is configured to collect purchase history specific to each customer, and derive, by processing the collected purchase history, a combined model that is built by combining temporal and aggregate models generated based on the purchase history, which in turn is used for a customer behavior prediction. In an embodiment, the temporal and aggregate models may be built based on data pertaining to multiple customers, however, for illustration purpose, the process is explained from single customer perspective, and this is not intended to impose any restriction in terms of scope. The purchase pattern is then used by the data analytics server 101 to classify a customer as a repeat customer or a non-repeating customer. In an embodiment, the data analytics server is configured to derive the purchase pattern based on a combination of temporal and aggregate features extracted from the purchase history. The data analytics server 101 is further configured to use a Mixture of Experts (ME) to combine the temporal and aggregate features so as to generate a combined model, which in turn is used to classify the customer as repeating or non-repeating customer. In an embodiment, ‘repeating customer’ as identified by the data analytics server 101 can be in terms of one or more of parameters such as but not limited to product, brand, offer, and store. In an embodiment, the ME processes temporal and aggregate features together to identify the purchase pattern, though the temporal and aggregate features are data of different types. The data analytics server 102 is further configured to use Long Short Term Memory (LSTM) as classifier over temporal features, and Quantile Regression (QR) as classifier over aggregate features. The temporal features can include any time instance related information with respect to various activities in the purchase history of the customer. For example, time series for the total duration are formed for each of the customer corresponding to different features, like number of different items a customer purchases daily/weekly (or within any time frame), and are used by the temporal model for learning. The time series for each feature consists of values of the feature over a period of time, for example, quantity of product bought for week1, followed by quantity of product bought for week2, and so on. Time series for several such features are considered such that a multivariate time series is formed. There are relations between different features, i.e. the dimensions of the multivariate time series as well as between values for features across time, which is captured in the temporal model, which in turn improves accuracy of the prediction. Repeat fraction of product, which is the ratio of number of customers who have purchased the product more than one time in the past to the number of customers who have purchased the product at least once in the past is also considered. Further, aggregate features can refer to any parameter that is associated with place/goods/location of any purchase as specified in the purchase history collected. For example, types of items purchased, quantity of each item purchased, number of each item purchased, store from which the items were purchased, price of items purchased, location of the stores and so on, over a period of time, are considered as aggregate parameters. Further, the data analytics server 101 is configured to collect the aggregate and temporal features from customer-based features, product-based features, and customer-product interaction based features. Customer-based features capture a customer's overall purchasing behavior in terms of total visits made, number of distinct products/brands he purchased from, loyalty of the customer i.e. ratio of number of times a customer purchased a product of a particular category, company and brand to the number of times the customer purchased any similar product belonging to same category, total spend, and the like. Product-based features are based on the concept that some offers have more repeaters compared to others, due to various reasons such as marketing strategy, discount given, quality and popularity of product on which offer is made and the like. Further, product based features are related to aspects of the product(s) on which offers are made. Features such as fraction of customers who become repeaters for the offer-product, and similarly, for the offer-product's brand, company, and the like, after a promotional campaign are considered. Customer-Product interaction based features capture affinity of a customer to the offer-product. Features such as the quantity bought, and amount spent by a customer on the offer-product, and similarly, on the offer-product's brand, company, and the like are considered.

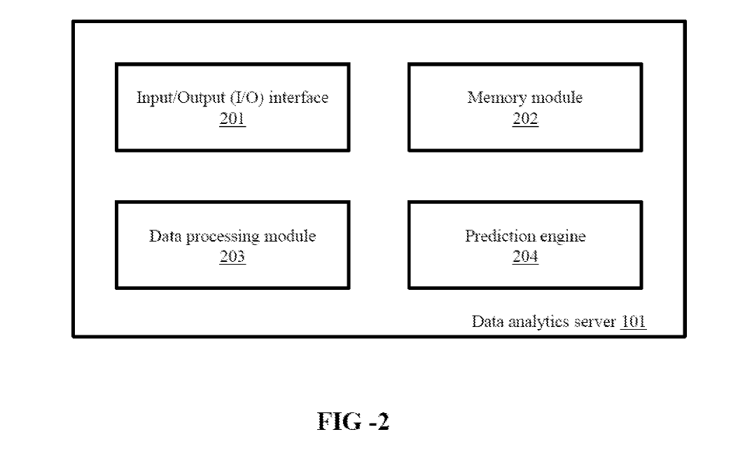

FIG. 2 is a block diagram that depicts components of a data analytics server of the data analytics system, in accordance with an example embodiment. The data analytics server 101 includes an Input/Output (I/O) interface 201, a memory module 202, a data processing module 203, and a prediction engine 204.

The I/O interface 201 is configured to provide at least one communication channel for the data analytics server 101 to establish communication with at least one user device 102 and exchange at least one type of data associated at least with the purchase behavior prediction. The I/O interface 201 can be configured to support suitable communication protocols, and different modes of communication (for example, wired communication, wireless communication and so on) as required.

The memory module 202 is configured to store any type of information associated with the purchase pattern identification and associated customer classification as repeating or non-repeating customer, temporarily or permanently, for the purpose of data processing as well as reference purposes, as required. For example, information such as but not limited to purchase history of customer, identified purchase pattern, and classification of the customer. In an embodiment, the data pertaining to each customer is mapped against the unique identification data that represents the customer. The unique identification data can be a number, letters, special characters, or a combination thereof, and is used to uniquely identify each customer and corresponding information.

The data processing module 203 can be configured to process the collected purchase history of a customer, and generate a combined model corresponding to the collected data. In this process, the data processing module 203 extracts temporal and aggregate features from the collected purchase history. In an embodiment of the present disclosure, the aggregate features (which is data of a first type) and the temporal features (which is data of a second type) are extracted based on features such as but not limited to at least one of total visits made by customers, total amount spent by customers, products purchased, brand of products purchased, loyalty, repeat fraction for each product, repeat fraction for brands, frequency of purchase, and quantity of each product bought, present in the purchase history. The data processing module 203 generates the aggregate model and a corresponding aggregate coefficient by using QR as a classifier over aggregate features. In an embodiment, the aggregate model is a data of a first type. The data processing module 203, by using LSTM as a classifier over temporal features, generates a temporal model and a corresponding temporal coefficient. In an embodiment, the temporal model is a data of a second type. In order to facilitate processing of the temporal model by the ME, the temporal model is processed by the data processing module 203 to extract at least one prediction from the temporal model, which in turn is provided as input to the ME, for processing along with an aggregate model and a plurality of aggregate features. In an embodiment, the at least one prediction from the temporal model can refer to a prediction made with respect to a purchase pattern of the customer, based on the temporal model.

The data processing module 203 further processes the temporal and aggregate models using the ME, and generates a combined model and a corresponding combined coefficient. In an embodiment, the at least one prediction from the temporal model is processed along with at least one prediction from the aggregate model, and a plurality of aggregate features, by the ME, though they are different types of data. The data processing module 203 is further configured to provide the combined coefficient as input to the prediction engine 204.

The prediction engine 204 is configured to perform a comparison of the combined coefficient with a threshold value of coefficient, and identify whether the customer is a repeat customer or not. In an embodiment, the threshold value of the coefficient is pre-configured, at the time of initial configuration of the data analytics system 100. In another embodiment, the threshold value of the coefficient is dynamically-configured using at least one suitable provision supported by the data analytics system 100. In an implementation scenario, if the value of combined coefficient is found to be exceeding the threshold value (i.e. a reference threshold), then the customer can be treated as a repeated customer, and if the value of combined coefficient is found to be less than that of the reference threshold, then the prediction engine 204 treats the customer as a non-repeating customer. However, these conditions and value of reference parameters can be changed or reversed as needed, dynamically or statically by an authorized person.

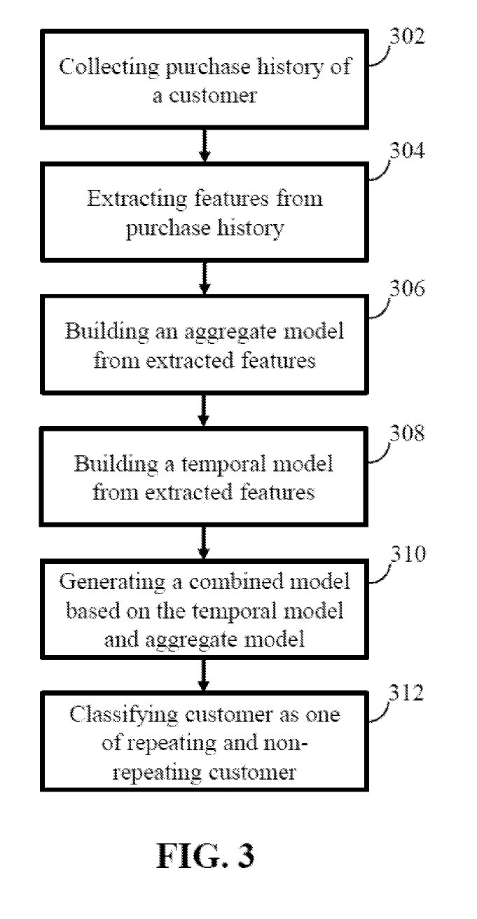

FIG. 3 is a flow diagram that depicts steps involved in the process of performing data analytics and prediction using the data analytics system, in accordance with an example embodiment. It is to be noted that data from multiple customers may be required to build the temporal and aggregate models. However, FIG. 3 and the description provided herein has explained the data analytics from a single customer perspective for illustration purpose, and is not intended to impose any restriction in terms of the number of customers considered and associated data being collected for the analytics purpose. In order to determine purchase pattern of a customer, the data analytics server 101 collects (302) purchase history of the customer as input. The data analytics server 101 further extracts (304) one or more features from the purchase history, using suitable data processing techniques, wherein the features include at least one aggregate feature and at least one temporal feature.

Further, the data analytics server 101 builds (306) an aggregate model based on the extracted aggregate feature(s). In an embodiment, the data analytics server 101 uses QR as a classifier over the aggregate feature(s) so as to generate the aggregate model and a corresponding aggregate coefficient. QR based aggregate model utilizes Quantile Regression (QR). Loss function for QR while used as the classifier for the aggregate features is q(y−p) I (y≥p)+(1−q) (p−y) I(y<p), where y is the actual value (label), p (=w_{q}.x) is the q-quantile prediction by regression (w_{q} is the weight vector and x is the aggregate feature vector for a customer) and I is the Indicator function with value 1 if it's argument is True and 0 otherwise. Positive data points (repeaters) get a weight of q and negative data points (non-repeaters) get a weight of (1−q) which allows for dealing with class-imbalance.

Similarly, the data analytics server 101 builds (308) a temporal model based on the extracted temporal feature(s). In an embodiment, the data analytics server 101 uses LSTM as a classifier over the temporal feature(s) so as to generate the temporal model and a corresponding temporal coefficient. In the LSTM based temporal model, n-dimensional time-series for a customer ‘c’ is represented as S_{c}={S_{c}⁽¹⁾, S_{c}⁽²⁾, . . . , S_{c}^{(T)}}, where each S_{c}^{(t)} € Rⁿ for t^{th} time-window, T is the length of time series. Each point in a time-series is a feature vector computed over a time-window. The network consists of n linear units in the input layer, LSTM units in hidden layer, and softmax output layer. LSTM units in a layer are fully connected through recurrent connections. For stacking LSTM layers, each unit in a lower LSTM hidden layer is fully connected via feed forward connections to each unit in the LSTM hidden layer above it. In an embodiment, the LSTM is a deep learning model.

The data analytics server 101 further generates a combined model and a combined threshold, based on the temporal model and the aggregate model. In an embodiment, the data analytics server 101 generates (310) the combined model by processing the temporal model and the aggregate model using the Mixture of Experts (ME). In ME over QR and LSTM models, given an input vector x, a ME assigns weights to predictions of models (experts)

$$y = {\sum }_{i = 1}^{n} {p}_{i} ( x ) {y}_{i} ( x )$$

where n is the number of experts, pᵢ(x) is the weight learnt by ME for the i^{th} expert, yᵢ(x) is the prediction score for i^{th} expert, and

$$y = {\sum }_{i = 1}^{n} {p}_{i} ( x ) {y}_{i} ( x ) = 1.$$

ME model utilizes the predictions given by aggregate and temporal models, and learns a weighted sum of the predictions. An aggregate feature vector as the input vector x is utilized. In the present case n=2 as there are 2 experts.

As the combined model features both temporal as well as aggregate information with respect to purchase history of the customer, the combined model provides a comprehensive view of purchase characteristics of the customer, based on which the customer is classified (312) as one of repeating and non-repeating customer, by the data analytics server 101. The various actions depicted in FIG. 3 can be performed in the order specified or in an alternate order, or some steps can be omitted if needed.

In an example case study, data with respect to Kaggle's “Acquired valued shopper's challenge” is considered. The data provided includes transaction history for customers for a period of at least 1 year prior to their offered incentive with attributes such as customer-id, store chain, department, product category, product company, product brand, date of purchase, purchase quantity, purchase amount, and the like. Features are extracted from the transaction data for the QR and LSTM models as described above. Total of 88 aggregate features for QR and 19 temporal features for LSTM are generated. Market-wise models are built for nine of the markets with a total of 38,000 customers. There are 28.8% customers from these nine markets who are repeaters. For each market, customers are randomly divided into training, validation, and test sets, the ratio of customers in the three sets is 3:1:1.

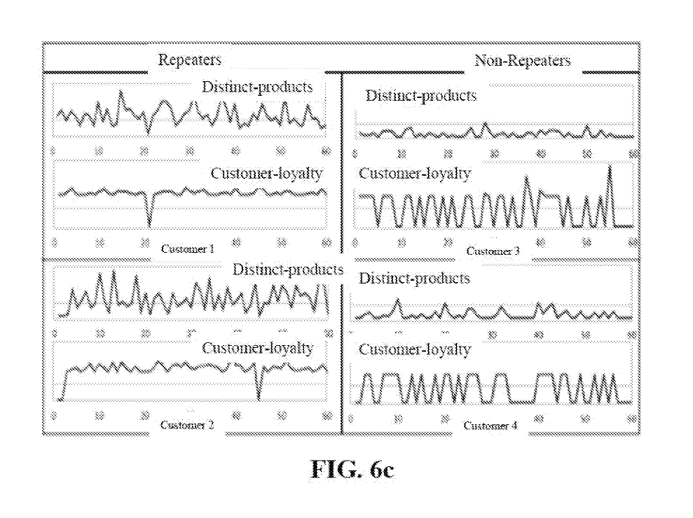

For the temporal model, each point in a time-series corresponds to weekly transactions, with resultant time-series of length 73 for each customer. Several deep and shallow architectures with up to 2 hidden layers (LSTM cells ranging from 5 to 25 for each hidden layer) are tried. LSTM network parameters such as momentum, weight decay, learning rate, and learning rate decay are considered. For the QR model, parameters such as q and learning rate are considered. Grid-search based parameter tuning is done on the validation set. As depicted in FIG. 6(a), significant improvement is seen in the ME model over the aggregate QR model. ME model has lower mean squared error (MSE) compared to the MSEs of the individual models. Time series for the total duration are formed for each of the customer corresponding to different features, like number of different items a customer purchases daily/weekly (or within any time frame), are used by the model for learning.

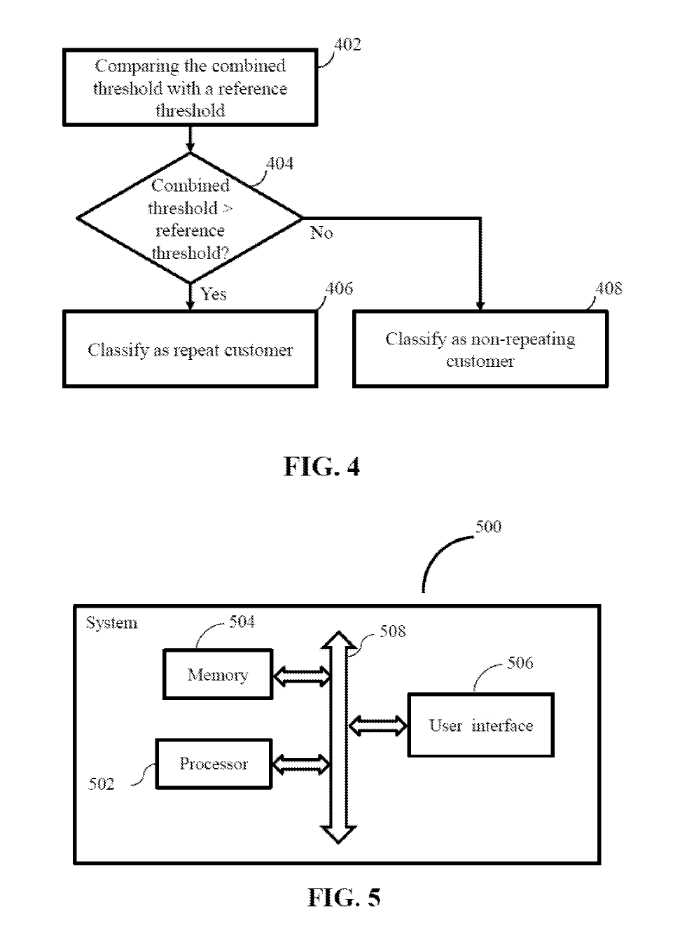

FIG. 4 is a flow diagram that depicts steps involved in the process of categorizing a customer as a repeater or non-repeater, using the data analytics system, in accordance with an example embodiment. The prediction engine 204 compares (402) the combined coefficient with a threshold value of coefficient (i.e. reference threshold), and checks (404) whether the value of combined threshold exceeds the reference threshold. In various embodiments, the threshold value of coefficient is statically or dynamically configured. If the value of combined coefficient is found to be exceeding the threshold value, then the customer is classified (406) as a repeated customer, and if the value of combined coefficient is found to be less than that of the reference threshold, then the prediction engine 204 classifies (408) the customer as a non-repeating customer. However, these conditions and value of reference parameters can be changed or reversed as needed, dynamically or statically by an authorized person. FIG. 6c depicts the difference in values of parameters for repeaters and non-repeaters, for the aforementioned example implementation scenario.

The various actions depicted in FIG. 4 can be performed in the order specified or in an alternate order, or some steps can be omitted if needed.

Example scenario that depicts efficiency of combination of aggregate and temporal features using ME over QR or LSTM based mechanisms is explained with the help of FIG. 6c.

FIGS. 6a, 6b, and 6c depict experimental data associated with working of the data analytics system, in accordance with an embodiment. Values in FIG. 6a indicate that combining the temporal (LSTM) and aggregate (QR) models improves accuracy of prediction, while FIG. 6b depicts, with help of t-distributed stochastic neighbor embedding (t-SNE) over Discrete Fourier Transform (DFT) coefficients of time series of features, that time series for repeaters and non-repeating customers is different. FIG. 6c indicates that time series for repeating and non-repeating customers is different, by considering two samples each for the time series of features for repeating and non-repeating customers. DFT coefficients of the time-series for repeaters and non-repeaters lie in separate low-dimensional embeddings indicating that there is a prominent discriminative signal in temporal data, and this further indicates that temporal model such as LSTM is successful in capturing temporal information in the data. For comparison of time-series for repeaters and non-repeaters, common features used in QR and LSTM models are considered. The actual value to be predicted by the models for a customer is set to either 1 (if customer is a repeater) or 0 (if customer is non-repeater). The DFT coefficients of time-series for customers that were correctly classified by LSTM and incorrectly classified by QR are computed. The resulting 37-dimensional representation of each customer is mapped to a 2-dimensional vector using t-SNE, as in FIG. 6b. The aggregate, temporal, and ME models used give probabilities of a customer being a repeating customer. These are used to classify customers into repeaters and non-repeaters by choosing a threshold between 0 and 1. If probability of a customer repeating a purchase is below the threshold, that particular customer is classified as non-repeater, and if the probability is above the threshold the customer is classified as repeater.

For this analysis, prediction is “repeater” if value of the combined threshold is above the threshold value of coefficient, else prediction is “non-repeater”. The threshold value of coefficient chosen is the one with maximum F-score on the validation set as known in the art. It is observed that although the values for the common features considered are very different for repeaters and non-repeaters in terms of aggregate features, the predictions by QR are incorrect; the corresponding time-series for these samples look very different in terms of amplitude and frequency, and are found to be useful for correct discrimination of repeaters from non-repeaters. The QR model captures the amplitude aspect of the time-series in terms of aggregate features. However, the QR model may not capture other aspects, such as frequency of time-series.

The ME learnt over LSTM model and QR model improves over QR model in terms of MSE. In the present example the purchase behavior with respect to products is considered but the same approach is also applicable to other scenarios involving prediction of repeat purchases by a customer for offers on merchants, brands and the like.

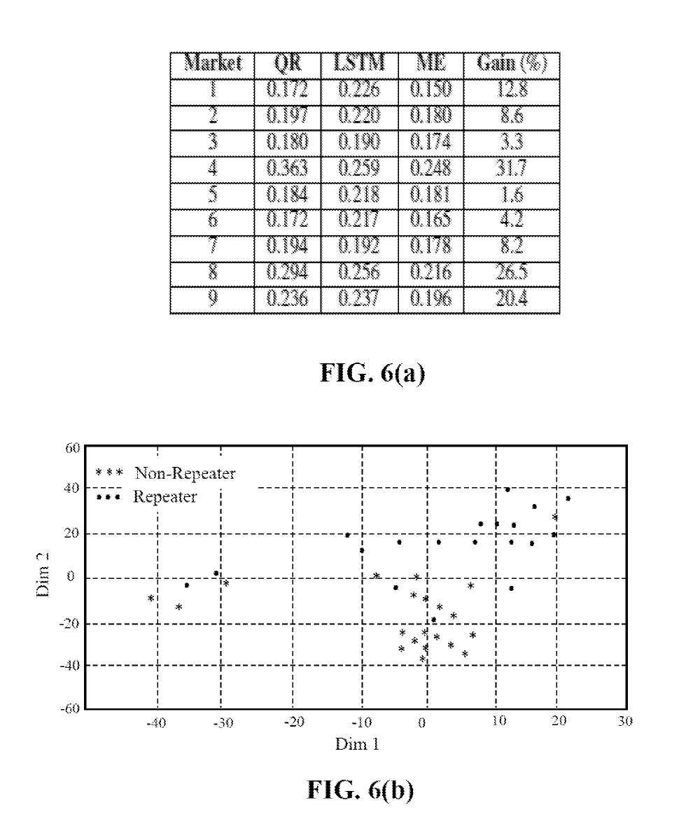

FIG. 5 is a block diagram of a system for generation of proof explanation in predicting purchase behavior of customers, in an embodiment. The system 500 can be embodied in a general-purpose computer suitable for use in performing the functions described herein with reference to FIGS. 1 through 4. The system 500 includes or is otherwise in communication with at least one memory such as a memory 502, at least one processor such as a processor 504, and a user interface 506. The memory 502, processor 504, the user interface 506, may be coupled by a system bus 508 or a similar mechanism.

In an embodiment, the processor 504 may include circuitry implementing, among others, audio and logic functions associated with the communication. For example, the processor 504 may include, but are not limited to, one or more digital signal processors (DSPs), one or more microprocessor, one or more special-purpose computer chips, one or more field-programmable gate arrays (FPGAs), one or more application-specific integrated circuits (ASICs), one or more computer(s), various analog to digital converters, digital to analog converters, and/or other support circuits. The processor 504 may include, among other things, a clock, an arithmetic logic unit (ALU) and logic gates configured to support operation of the processor 504. Further, the processor 504 may include functionality to execute one or more software programs, which may be stored in the memory 502 or otherwise accessible to the processor 504.

The at least one memory such as a memory 502, may store any number of pieces of information, and data, used by the call control server to implement the functions of the call control server. The memory 502 may include for example, volatile memory and/or non-volatile memory. Examples of volatile memory may include, but are not limited to volatile random access memory (RAM). The non-volatile memory may additionally or alternatively comprise an electrically erasable programmable read only memory (EEPROM), flash memory, hard drive, or the like.

In an example embodiment, a user interface 506 may be in communication with the processor 504. Examples of the user interface 506 include but are not limited to, input interface and/or output user interface. The input interface is configured to receive an indication of a user input. The output user interface provides an audible, visual, mechanical or other output and/or feedback to the user. In an example embodiment, the user interface 506 may include, among other devices or elements, any or all of a speaker, a microphone, a display, and a keyboard, touch screen, or the like. In this regard, for example, the processor 504 may comprise user interface circuitry configured to control at least some functions of one or more elements of the user interface 506, such as, for example, a speaker, ringer, microphone, display, and/or the like. The processor 504 and/or user interface circuitry comprising the processor 504 may be configured to control one or more functions of one or more elements of the user interface 506 through computer program instructions, for example, software and/or firmware, stored on a memory, for example, the at least one memory 502, and/or the like, accessible to the processor 504.

In an embodiment, the system 500 is caused to interconnect all the models in the architecture for predicting customer behavior. The system is further caused to enable percolation of features extracted from the transaction history of the customers to the aggregate model, temporal model and ME models. The system 500 may further be caused to digitize the features extracted from the transaction history and the meta-data, and execute the process of classification of customers. The system 500 may further be caused to consolidate results of the various models utilized and provide reports. Additionally, the system is caused to automate the flow of process from one model to the other for classification of customers as repeaters and non-repeaters.

In an embodiment, for performing the functionalities associated with different layers (described with reference to FIGS. 1 to 4), the memory 504 of the system 500 may include multiple modules or software programs that may be executed by the processor 502. For instance, the memory may include modules for storing the transaction history data with attributes such as customer-id, store chain, department, product category, product company, product brand, date of purchase, purchase quantity, purchase amount and the like of various customers.

Various methods and systems for customer behavior prediction disclosed herein enables prediction of repeaters and non-repeaters by utilizing temporal information gathered from transaction data along with aggregate information. Deep learning model is utilized to learn from the time series and to classify the customers by capturing the temporal patterns in the buying behavior of the customers.

1. A method for customer behavior assessment, said method comprising:
fetching dynamically, by a data analytics server, a purchase history of at least one customer, wherein said purchase history comprises of at least one of customer features, product features, and customer-product interaction features;
generating, by a data analytics server, an aggregate model for said purchase history;
generating, by said data analytics server, a temporal model for said purchase history;
determining, by said data analytics server, a combined model based on said aggregate model and said temporal model, using Mixture of Experts (ME); and
classifying, by said data analytics server, said at least one customer as one of a repeat customer and a non-repeat customer, based on said combined model.

2. The method as claimed in claim 1, wherein the combined model is determined by processing the temporal model along with the aggregate model by:
extracting, by said data analytics server, at least one prediction from the temporal model;
extracting, by said data analytics server, at least one prediction from the aggregate model; and
processing, by said data analytics server, said at least one prediction extracted from the temporal model, said at least one prediction extracted from the aggregate model, and a plurality of aggregate features.

3. The method as claimed in claim 1, wherein the customer features, product features, and customer-product interaction features are at least one of total visits made by customers, total amount spent by customers, products purchased, brand of products purchased, loyalty, repeat fraction for each product, Repeat fraction for brands, frequency of purchase, and quantity of each product bought.

4. The method as claimed in claim 1, wherein classifying the customer as one of repeat customer and a non-repeat customer further comprises of:
generating a combined coefficient pertaining to said combined model;
performing a comparison of said combined coefficient and a threshold value of coefficient; and
classifying the customer as a repeat customer or a non-repeat customer based on the comparison.

5. The method as claimed in claim 1, wherein said aggregate model is generated by using Quantile Regression (QR) as classifier, by said data analytics server.

6. The method as claimed in claim 1, wherein said temporal model is generated by using Long Short Term Memory (LSTM) as classifier, by said data analytics server.

7. A data analytics server for customer behavior assessment, said data analytics server comprising:
a hardware processor; and
a storage medium comprising a plurality of instructions, said plurality of instructions causing the hardware processor to:
fetch dynamically, a purchase history of at least one customer, by an Input/Output (I/O) interface of the data analytics server, wherein said purchase history comprises of at least one of customer features, product features, and customer-product interaction features;
generate an aggregate model for said purchase history, by a data processing module of the data analytics server, wherein said aggregate model comprises of data of a first type;
generate a temporal model for said purchase history, by said data processing module, wherein said temporal model comprises of data of a second type;
determine a combined model based on said aggregate model and said temporal model, using Mixture of Experts (ME), by said data processing module, wherein said ME determines said combined model by processing said data of the first type and said data of the second type; and
classify said at least one customer as one of a repeat customer and a non-repeat customer, based on said combined model, by a prediction engine of the data analytics server.

8. The data analytics server as claimed in claim 7, wherein the data processing module determines the combined model by processing the temporal model along with the aggregate model by:
extracting at least one prediction from the temporal model;
extracting at least one prediction from the aggregate model; and
processing said at least one prediction extracted from the temporal model, said at least one prediction extracted from the aggregate model, and a plurality aggregate features.

9. The data analytics server as claimed in claim 7, wherein said I/O interface is configured to fetch at least one of total visits made by customers, total amount spent by customers, products purchased, brand of products purchased, loyalty, repeat fraction for each product, repeat fraction for brands, frequency of purchase, and quantity of each product bought, as said purchase history.

10. The data analytics server as claimed in claim 7, wherein said data processing module is configured to generate the aggregate model by using Quantile Regression (QR) as classifier.

11. The data analytics server as claimed in claim 7, wherein said data processing module is configured to generate the temporal model by using Long Short Term Memory (LSTM) as classifier.

12. The data analytics server as claimed in claim 7, wherein said prediction engine classifies the customer as one of repeat customer and a non-repeat customer by:
performing a comparison of a combined coefficient pertaining to said combined model and a threshold value of coefficient; and
classifying the customer as a repeat customer or a non-repeat customer based on the comparison.
